(19) United States
(12) Patent Application Publication
(10) Pub. No.: US 2009/0211077 A1
(43) Pub. Date: Aug. 27, 2009

(54) Method and apparatus for the connection of objects

(75) Inventor: Joachim Wein, Deisslingen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Maschinenfabrik Spaichingen GmbH, Spaichingen (DE)

(21) Appl. No.: 12/380,223

(22) Filed: Feb. 24, 2009

(30) Foreign Application Priority Data
Feb. 26, 2008 (DE) 10 2008 011 151.1

(51) Int. Cl. B21J 15/08; B23P 11/00

(52) U.S. Cl. 29/525.07; 29/243.519

(57) ABSTRACT

In a method for the connection of objects by means of at least one plasticizable hollow cylindrical rivet peg which can be heated by application of a process element which is provided, at its process side to be placed onto the hollow cylindrical rivet peg, with a spigot which can be introduced into the hollow space of the rivet peg and with an annular cut-out surrounding it, a rivet head is formed at the rivet peg by application and follow-up movement of the process element and the process element is subsequently removed from the formed rivet head. In this respect, a spreading effect directed from the inside to the outside is exerted onto the rivet peg generally transversely to the follow-up movement direction during the follow-up movement of the process element by its spigot entering into the hollow space of the rivet peg and the rivet peg is beaded over in the doughy state to form the rivet heat. A corresponding apparatus for the connection of objects is also set forth.

### CROSS-REFERENCE TO RELATED APPLICATION

This application claims priority to German Application No. 10 2008 011 51.1, filed Feb. 26, 2008, the disclosure of which is incorporated herein by reference.

The invention relates to a method for the connection of objects by means of at least one plasticizable hollow cylindrical rivet peg, wherein the rivet peg can be heated by application of a process element which is provided, at its process side to be placed onto the hollow cylindrical rivet peg, with a spigot which can be introduced into the hollow space of the rivet peg and with an annular cut-out surrounding it, wherein a rivet head is formed at the rivet peg by application and follow-up movement of the process element and wherein the process element is subsequently removed from the formed rivet head. It further relates to an apparatus of the type set forth in the preamble of claim 10.

Methods and apparatus of this kind work according to the so-called rivet peg welding principle according to which a connection element having a projection formed at it, the so-called rivet peg, and provided at one of the objects is first pushed through the opening of the other object and the free end of the rivet peg is then provided with a shaped rivet head. The connection element in this respect can also be made from a separate component which is pushed through both objects and has an already previously applied head at one end.

In most cases, at least one of the two joining partners is made from a plasticizable plastic. It is, however, basically sufficient if only the participating connection elements or the rivet pegs provided thereat are made of a plasticizable material.

Various methods are known for the heating and for the plasticizing of the rivet pegs. Ultrasonic welding is e.g. widely used. In this respect, ultrasonic oscillation tools, so-called sonotrodes, onto which the rivet pegs are placed to set them into radio frequency oscillation and thereby to heat the connection elements and rivet pegs accordingly.

Since problems can occur with such an ultrasonic welding process, e.g. in the field of automotive door trims, after some of the ultrasound has been conducted further from the rivet pegs into the workpiece and the foamed layers can collapse into one another at some points, it has also already been proposed to apply the heat by means of a heated cap insert and to weld the rivet peg down by additional application of mechanical pressure (cf. EP 1 661 689 A2). So that as little mass as possible has to be cooled and heated again, whereby time is correspondingly saved, the cap insert is decoupled from the heat carrier for cooling. After cooling, the cap insert couples to the heat carrier and is heated again.

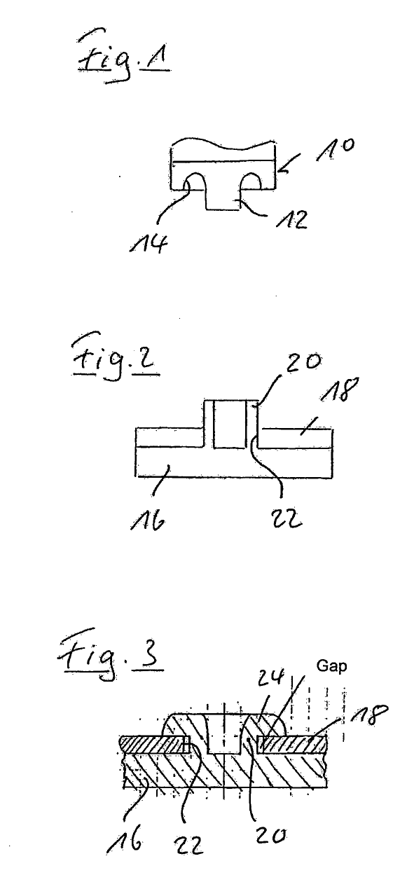

FIG. 1 shows in a schematic representation a conventional heatable cap 10 used in the previously applied method and having at least substantially circular cylindrical pegs 12 and an annular cut-out 14 surrounding it.

Two objects 16, 18 to be connected to one another are shown schematically in FIG. 2, with a rivet peg 20 associated with the one object 16 being pushed through an opening 22 of the other object 18. As already mentioned, a separate connection element having the rivet peg can also in particular be provided.

In the known method, the planar surface of the rivet peg 20 is now heated via the contact surface of the conventional hot cap 10 shown in FIG. 1 and is superficially plasticized so that the rivet peg 20 is gradually plasticized “layer-wise” and is reshaped with a low application of force. In this respect the plastic forming the rivet peg 20 flows off outwardly in a small layer thickness. In the course of the further welding process, the plasticized plastic is pressed into the molding 14 of the cap 10 and is transformed into a mush-like state in its region.

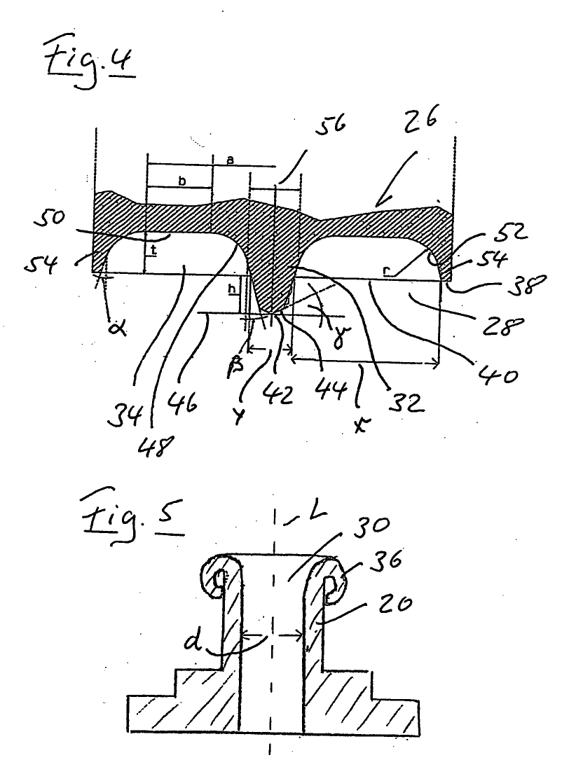

The plastic is then molded in this mush-like state using the cap 10 to such a rivet head 24, for example, such as results from FIG. 3. In this known method, the rivet head 24 does not, however, connect to the peripheral surface of the rivet peg within the rivet head due to the mush-like consistency. After the complete cooling down of the rivet head 24, a thin force-transmitting layer thus results of only a few tenths of a millimeter which is shorn off on a removal attempt. The respective removal forces are correspondingly small. As can be seen with reference to FIG. 3, a gap remains between the rivet peg 20 and the object 18, which has the result that the connection is not clatter-free.

It is the underlying object of the invention to provide an improved method and an improved apparatus of the initially named kind with which the previously mentioned disadvantages have been eliminated. It should in particular be achieved in this respect that higher removal forces result.

This object is satisfied in accordance with the invention with respect to the method in that a spreading effect directed from the inside to the outside is exerted onto the rivet peg generally transversely to the direction of the follow-up movement during the follow-up movement of the process element by its spigot entering into the hollow space of the rivet peg and the rivet peg is beaded over for the shaping of the rivet head in the doughy (i.e. formable or plastic) state.

As a result of the annular spreading effect onto the rivet peg starting from the inner diameter of the rivet peg in conjunction with a smaller heating of the rivet peg with respect to the known method and with a correspondingly greater application of force for the follow-up movement of the process element, the rivet peg is, unlike in the known method, no longer melted off, but is beaded over in a doughy state and is thereby shaped into a rivet head. A much thicker force-transmitting layer results due to this beading over process so that the rivet head is not sheared off on removal load but is rather torn off, which brings along substantially higher removal forces. In the course of the follow-up movement of the process tool, the doughy material is additionally pressed into the air gap which may be present between the upper object and the rivet peg, whereby said rivet peg is clamped centrally and a jolt-free connection is achieved.

The rivet peg is therefore preferably only heated so much that it is transformed into the doughy state and a melting off is prevented.

Expediently, the rivet peg is heated in dependence on the rivet peg material up to a temperature in the range of approximately 170 to approximately 250° C., and the respective temperature should, however, be below the melting temperature of the rivet peg material.

The force with which the process element is pressed against the rivet peg is selected to be correspondingly higher in comparison with the known method so that the process element applied to the rivet peg follows up the rivet peg adopting its doughy state and the rivet peg is beaded over in this doughy state.

The rivet head is preferably formed at an at least substantially circular cylindrical rivet peg, for which purpose a process element is used having a rotationally symmetrical spigot and a rotationally symmetrical annular cut-out. Generally, however, a process element is also conceivable having a spigot elongate in cross-section and a correspondingly elongate annular cut-out for the formation of the rivet head at a rivet peg elongate in cross-section.

In accordance with an advantageous practical aspect of the method in accordance with the invention, a heatable cap is used as the process element. In this respect, the heating of such a cap can take place, for example, with the help of a heating element which can follow it up, as is described in EP 1 661 689 A2. The cap is expediently only removed from the rivet head after a cooling thereof. To accelerate the cooling, the heating element can be separated from the cap before the removal of the cap from the rivet head.

In accordance with an alternative advantageous aspect of the method in accordance with the invention, a sonotrode is used as the process element. Such a sonotrode can form a resonant unit together with a converter. In this respect, the sonotrode is excited via the converter comprising, for example, a piezoelectrode crystal, to make ultrasonic oscillations via which the rivet peg is then correspondingly heated.

A further preferred aspect of the method in accordance with the invention is characterized in that the heating of the process element preferably formed by a heatable cap takes place by means of a heating element which can follow up the process element and in that the heating element is separated from the rivet head for the acceleration of the cooling before the removal of the process element from the rivet head. It is of advantage in this respect if the process element is cooled by a cooling medium, for example a gaseous cooling medium, after the separation from the heating element and before the removal from the rivet head.

The welding process can thus be carried out with a comparatively small separating effort and with a high process speed, that is with shorter cycle durations than previously, both for the plasticizing phases and for the following cooling phases. The process element preferably provided in the form of a cap can receive a comparatively small volume or a small mass. A fast plasticizing of the rivet pegs is nevertheless possible, on the one hand, in that a sufficiently powerful heating element is at least brought into the vicinity of the cap or is applied to it, whereas, on the other hand, a fast cooling of the cap and thus of the rivet heads manufactured can also be achieved, in particular in that the heating element is removed from the cap during or directly after the molding of the rivet heads from the cap.

Such a heating or cooling of the cap is known per se from DE 10 2004 057 453 B3. The heating of the process element or of the tray as well as their cooling can also be provided in another respect as it is described in DE 10 2004 057 453 B3 which is herewith included in the disclosure content of the present application.

The apparatus in accordance with the invention is correspondingly characterized in that the spigot and the annular cut-out of the process element surrounding it are made such that on the follow-up movement of the process element applied to the rivet peg a spreading effect directed from the inside to the outside is exerted onto the heated rivet peg having a doughy state generally transversely to the longitudinal direction of the rivet peg and the rivet peg is beaded over in the doughy state for the shaping of the rivet head.

The process element preferably has a support surface at its process side which surrounds the cut-out in an annular manner and with which it lies on one of the objects to be connected to one another at the end of its follow-up movement.

In this respect, the spigot of the process element expediently projects beyond the plane of this support surface.

The process element is preferably rotationally symmetrical.

A preferred practical embodiment of the apparatus in accordance with the invention is characterized in that the spigot, starting from its outer end projecting beyond the plane of the support surface, has an outer diameter which becomes increasingly larger toward the inside.

Whereas the outer diameter of the spigot in the plane of the support surface can be at least substantially the same as the inner diameter of the hollow cylindrical rivet peg, or can also be somewhat smaller than it, the outer diameter of the spigot is preferably larger than the inner diameter of the hollow cylindrical rivet peg, at least in the region disposed within the plane of the support surface when considered in the longitudinal direction of the rivet peg, whereby the spreading effect is achieved on the rivet peg on the follow-up movement of the process element.

The spigot can have a conical or truncated conical shape at least sectionally.

In this respect, the peripheral surface of the conical or truncated conical section of the spigot advantageously includes an angle in the range of approximately 15° with the longitudinal direction of the rivet peg.

The spigot preferably merges over a curved wall section into the base of the annular recess.

In addition, the base of the annular recess can merge over a curved wall section into the wall bounding the recess outwardly and adjoining the support surface.

The width of the at least substantially planar base of the cut-out defining the maximum depth of the annular cut-out is preferably larger than the outer diameter of the spigot in the plane of the support surface.

It is in particular also of advantage if the wall outwardly bounding the cut-out is outwardly inclined by an angle in the range of approximately 15° in the region of the support surface with respect to the longitudinal direction of the rivet peg.

Expediently, considered in the plane of the support surface, the width of the annular cut-out is larger than the diameter of the spigot. In this respect, considered in this plane of the support surface, the width of the annular cut-out can be in particular at least twice as large, and preferably at least three times as large, as the diameter of the spigot.

It is in particular also of advantage if the maximum depth of the cut-out measured starting from the plane of the support surface is larger than the height of the part of the spigot projecting beyond the plane of the support surface.

The ratio between the maximum depth of the cut-out and the height of the part of the spigot projecting beyond the plane of the support surface is preferably in a range between approximately 1.4 and approximately 1.7.

Means are expediently provided to control and/or regulate the heating of the rivet peg such that it is only heated so much that it is transformed into the doughy state and a melting off is prevented.

Expediently, means can in particular also be provided to control and/or regulate the force with which the process element is pressed against the rivet peg such that the process element applied to the rivet peg follows up the rivet peg adopting its doughy state and such that the rivet peg is beaded over in this doughy state.

In accordance with a preferred embodiment of the apparatus in accordance with the invention, the process element for the formation of the rivet head at an at least substantially circular cylindrical rivet peg is provided with a rotationally symmetrical spigot and a rotationally symmetrical annular cut-out. As already mentioned, a process element is, however, also conceivable with a spigot elongate in cross-section and a correspondingly elongate cut-out for the formation of a rivet head elongate in cross-section.

The process element is preferably formed by a heatable cap or the like.

In accordance with an alternative advantageous embodiment, the process element can, however, also be formed by a sonotrode.

A preferred practical embodiment of the apparatus in accordance with the invention is characterized in that the process element preferably formed by a heatable cap is associated with a riveting tool which is movable forward and backward in the direction of the rivet peg and which additionally includes a heating element which is designed for the heating of the process element and which is movable relative to the process element. In this respect, the heating element is preferably made as a heat accumulator. In addition, means are advantageously provided for the cooling of the process element.

A corresponding heating element as well as corresponding cooling means are already known from DE 10 2004 057 453 B3. The means for the heating or cooling of the process element can also be made in another respect as is described in DE 10 2004 057 453 B3 which is herewith included in the disclosure content of the present application.

The invention will be explained in more detail in the following with reference to an embodiment and to the drawing; there are shown in this:

FIG. 1 a schematic sectional representation of a conventional heatable cap;

FIG. 2 a schematic sectional representation of two objects to be connected to one another, wherein a rivet peg associated with the one object is pushed through an opening of the other object;

FIG. 3 a connection between the two objects manufactured with the conventional cap in accordance with FIG. 1 in accordance with a conventional method;

FIG. 4 a schematic sectional representation of an exemplary embodiment of the process element in accordance with the invention;

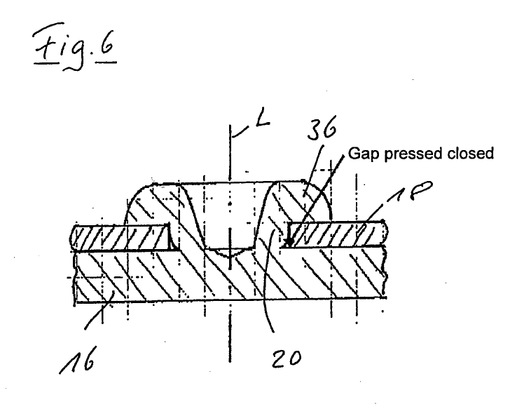

FIG. 5 a schematic sectional representation of a rivet head formed at a rivet peg, for example, by means of the process element in accordance with FIG. 4 in accordance with the method in accordance with the invention; and

FIG. 6 a connection between the two objects established with a cap in accordance with the invention or in accordance with a method in accordance with the invention.

FIG. 4 shows in a schematic sectional representation an exemplary embodiment of a process element 26 in accordance with the invention of an apparatus for the connection of objects 16, 18 (cf. also FIG. 2) by means of a plasticizable hollow cylindrical rivet peg 20 (cf. also FIG. 5).

This process element 26 is movable in the longitudinal direction L of the hollow cylindrical rivet peg 20 and can be pressed toward the rivet peg 20 in this direction. In this connection, the rivet peg 20 can be heated by application of the process element 26.

As can be recognized with reference to FIG. 4, the process element 26 is provided at its process side 28 which can be placed onto the hollow cylindrical rivet peg 20 with a spigot 32 which can be introduced into the hollow space 30 of the rivet peg 20 and with an annular cut-out 34 surrounding it. A rivet heat 36 (cf. FIG. 5 is then formed at the rivet peg 20 by application and follow-up movement of the process element 26. The process element 26 is subsequently removed from the rivet head 36.

In accordance with the method in accordance with the invention, a spreading effect directed from the inside to the outside is exerted onto the rivet peg generally transversely to the direction of the follow-up movement, i.e. generally transversely to the longitudinal direction L of the rivet peg 20, during the follow-up movement of the process element 26 by its spigot 32 entering into the hollow space 30 of the rivet peg 20 and the rivet peg 20 is beaded over in the doughy state for the shaping of the rivet head 36. The rivet peg 20 is therefore only heated so much that it is transformed into the doughy state and a melting off is prevented. In this connection, the rivet peg 20 can in particular be heated up to a temperature in the range from approximately 170 to 250° C. in dependence on its material.

The force with which the process element 26 is pressed toward the rivet peg 20 is selected to be so high that the process element 26 applied to the rivet peg 20 follows up the rivet peg 20 adopting its doughy state and the rivet peg 20 is beaded over in this doughy state (cf. FIG. 5).

In the present embodiment, the rivet head 36 is formed at an at least substantially circular cylindrical rivet peg 20, for which purpose the process element 26 is provided with a rotationally symmetrical spigot 32 and with a rotationally symmetrical annular cut-out 34. The process element 26 in the present case is also preferably made rotationally symmetrical in another respect.

The process element 36 can, for example, be a heatable cap or also a sonotrode, for example.

The spigot 32 and the annular cut-out 34 of the process element 26 surrounding it are therefore made such that a spreading effect directed from the inside to the outside is exerted onto the heated rivet peg 20 having a doughy state generally transversely to the longitudinal direction L of the rivet peg 20 during the follow-up movement of the process element 26 applied to the rivet peg 20 and the rivet peg 20 is beaded over in the doughy state for the shaping of the rivet head 36.

As can be recognized with respect to FIG. 4, the process element 36 has on its process side 28 a support surface 38 which surrounds the cut-out 34 in annular form and with which it lies, at the end of its follow-up movement, on one of the objects 16, 18 to be connected to one another, i.e. in the case of FIG. 2 on the upper object 18.

The spigot 32 of the process element 26 projects by the amount h beyond the plane 40 of the support surface 38.

In addition, the spigot 32 of the process element 26 made e.g. rotationally symmetrical here has, starting from its outer end 42 projecting beyond the plane 40 of the support surface 38, an outer diameter becoming larger toward the inside, i.e. upwardly in the representation in accordance with FIG. 4. In this respect, this outer diameter of the spigot 32 can at least substantially be the same as the inner diameter d of the hollow cylindrical rivet peg 20 in the plane 40 of the support surface 38.

As can be recognized with reference to FIG. 4, the outer diameter of the spigot 32 is, at least in the region disposed within the plane 40 of the support surface 38 considered in the longitudinal direction L of the rivet peg 20, i.e. above the plane 40 in the representation of FIG. 4, larger than the inner diameter of the hollow cylindrical rivet peg, whereby the previously mentioned spreading effect results on the follow-up movement of the process element 26.

As can likewise again be seen from FIG. 4, the spigot 32 can have a conical or truncated conical shape at least section-wise. In the present embodiment, the peripheral surface of the conical or truncated conical section of the spigot 32 includes an angle β in the range of approximately 15° with the longitudinal direction L of the rivet peg 20.

In the region of the outer end 42, the spigot 32 can be provided with an annular chamfer 44 which in the present embodiment can include an angle γ in the range of 28° with the horizontal, for example.

The spigot 32 merges over a curved wall section 48 into the base 50 of the annular recess 34.

The base 50 of the annular recess 34 merges over a curved wall section 52 into the wall 54 outwardly bounding the recess 34 and adjoining the support surface 38.

The width b of the at least substantially planar base 50 of the cut-out 34 defining the maximum depth t of the annular cut-out 34 is larger than the outer diameter of the spigot 32 in the plane 40 of the support surface 38.

The wall 54 outwardly bounding the cut-out 34 can, for example, be outwardly inclined by an angle α in the range of approximately 15° with respect to the longitudinal direction L of the rivet peg 20 in the region of the support surface 38.

As can additionally be seen from FIG. 4, the width of the annular cut-out 34 considered in the plane 40 of the support surface 38 is larger than the diameter of the spigot 32. In this respect, considered in the plane 40 of the support surface 38, the width of the annular cut-out 34 can in particular be at least twice as large, and preferably at least three times as large, as the diameter of the spigot 32.

In the present embodiment, the maximum depth t of the cut-out 34 measured starting from the plane 40 of the support surface 38 is larger than the height h of the part of the spigot 32 projecting beyond the plane 40 of the support surface 38. In this respect, the ratio between the maximum depth t of the cut-out 34 and the height h of the part of the spigot 32 projecting beyond the plane 40 of the support surface 38 can in particular be in a range between approximately 1.4 and approximately 1.7.

The respective apparatus for the connection of the objects 16, 18 can in particular include means to control and/or to regulate the heating of the rivet peg 20 such that it is only heated so much that it is transformed into the doughy state and a melting off is prevented. In addition, the apparatus can include means to control and/or regulate the force with which the process element 26 is pressed toward the rivet peg 20 such that the process element 26 applied to the rivet peg 20 follows up its rivet peg adopting the doughy state and the rivet peg 20 is beaded over in this doughy state.

The radius of curvature r of the curved wall section 52 can lie, for example, in the range of 2 mm. The maximum depth t of the cut-out 34 or supply depth can lie, for example, in a range from approximately 1.8 mm to approximately 2.05 mm. The width b of the base 50 or of the turn-out path can lie, for example, in a range from approximately 0.17 to approximately 1.35 mm. The diameter y of the spigot 32 in the plane 40 of the support surface 38 can lie, for example, in a range from approximately 3.9 to approximately 5.5 mm. The width x of the annular recess 34 measured in the radial direction and defined by the difference between the outer radius and the inner radius in the plane 40 of the support surface 38 as a control dimension for the diameter of the rivet head can lie, for example, in a range from approximately 13.3 to 15.8 mm. The spacing a between the center 56 and the transition region between the base 50 and the curved wall section 52 can lie, for example, in a range from approximately 4.6 to approximately 5.8 mm. The volume of the process element 26 or of the annular recess 34 can lie, for example, in a range between approximately 170 and approximately 300 mm³. The values set forth are, however, purely exemplary and depend, among other things, on the respective dimensions of the rivet peg and of the rivet head to be formed as well as on the material of the rivet peg.

In the following Table 1, some dimensional examples for a round rivet cap are shown:

TABLE 1

| | | Parameters | | | | | | |
|---|---|---|---|---|---|---|---|---|
| Cap | Volume | x | y | r | t | a | b | H |
| 6 | 298 mm³ | 15.74 | 4.70 | 2.00 | 2.05 | 5.79 | 1.35 | 1.26 |

Welding trials were carried out to determine whether, for example, cycle times of ≦38 s and strengths of ≧300 N can be achieved with a heatable cap with rivet peg diameters of, for example, 8 mm with a rivet peg length of, for example, 9 mm.

The demands were easily satisfied, with welding times of <30 s and strengths of >400 n being achieved.

It was a precondition in this respect that the cycle time is made up of the sum from the welding time and the process time (e.g. rotating the turntable, etc.).

In this respect, the outer diameter is respectively marked by “D”, the inner diameter respectively by “d” and the length of the respective rivet peg respectively by “L”.

TABLE 2
Material: Schulablend (ABS/PA) M/MK 2004
Rivet peg: D = 8 mm/d = 5.5 mm
Cap 6: t = 2.05 mm/2x + y = 15.74 mm (depth/outer diameter)

| Welding | Welding | Holding | Cooling | Welding | Tensile |
|---|---|---|---|---|---|
| temperature | pressure | time | time | time | test |
| 220° C. | 4.4 bar | 5 s | 10 s | 27.4 s | 480 N |
| | | | | 27.4 s | 442 N |
| | | | | 27.5 s | 560 N |
| | | | | 27.5 s | 585 N |
| | | | | 27.6 s | 501 N |

Trials were carried out with different rivet peg diameters (4-8 mm), different materials, also materials containing glass fiber, and different lengths. They influence the parameters of force and temperature and accordingly also result in different welding times.

The welding force was between 200 and 600 N in the trials substantially in dependence on the material and on the diameter. Too high a welding force results in a tearing of the rivet peg and thus to reduced and uncontrolled removal forces.

FIG. 6 shows a cap 26 in accordance with the invention and a connection between the two objects 16, 18 established in accordance with the method in accordance with the invention. As results from this FIG. 6, the gap between the rivet peg 20 and the object 18 is pressed closed due to the spreading in accordance with the invention, whereby a rattle-free connection is ensured.

### REFERENCE NUMERAL LIST

10 cap

12 spigot

14 annular cut-out

16 object

18 object

20 rivet peg

22 opening

24 rivet head

26 process element, cap, sonotrode

28 process side

30 hollow space

32 spigot

34 annular cut-out

36 rivet head

38 support surface

40 plane

42 outer end

44 chamfer

46 horizontal

48 curved wall section

50 base

52 curved wall section

54 wall

56 center

L longitudinal direction

1. A method for the connection of objects (16, 18) by means of at least one plasticizable hollow cylindrical rivet peg, (20) wherein the rivet peg (20) can be heated by application of a process element (26) which is provided, at its process side (28) to be placed onto the hollow cylindrical rivet peg (20), with a spigot (32) which can be introduced into the hollow space (30) of the rivet peg (20) and with an annular cut-out (34) surrounding it, wherein a rivet head (36) is formed at the rivet peg (20) by application and follow-up movement of the process element (26) and wherein the process element (26) is subsequently removed from the formed rivet head (36),
characterized in that
a spreading effect directed from the inside to the outside is exerted onto the rivet peg (20) generally transversely to the direction of the follow-up movement during the follow-up movement of the process element by its spigot (32) entering into the hollow space (30) of the rivet peg (20) and the rivet peg (20) is beaded over in the doughy state for the shaping of the rivet head (36).

2. A method in accordance with claim 1, characterized in that the rivet peg (20) is only heated so much that it is transformed into the doughy state and a melting off is prevented.

3. A method in accordance with claim 2, characterized in that the rivet peg (20) is heated via the process element (26) up to a temperature in the range from approximately 170 to approximately 250° C. in dependence on the rivet peg material.

4. A method in accordance with claim 1, characterized in that the force with which the process element (26) is pressed toward the rivet peg (20) is selected to be so high that the process element (26) applied to the rivet peg (20) follows up the rivet peg (20) adopting its doughy state and the rivet peg (20) is beaded over in this doughy state.

5. A method in accordance with claim 1, characterized in that the rivet head (36) is formed at an at least substantially circular cylindrical rivet peg (20) and, for this purpose, a process element (26) is used having a rotationally symmetrical spigot (32) and having a rotationally symmetrical annular cut-out (34).

6. A method in accordance with claim 1, characterized in that a heatable cap is used as the process element (26).

7. A method in accordance with claim 1, characterized in that a sonotrode is used as the process element (26).

8. A method in accordance with claim 1, characterized in that the heating of the process element (26) preferably formed by a heatable cap takes place by means of a heating element which can follow-up the process element (26) and the heating element is separated from the rivet head (36) for the acceleration of the cooling before the removal of the process element (26) from the rivet head.

9. A method in accordance with claim 8, characterized in that the process element (26) is cooled after the separation from the heating element and before the removal from the rivet head (36) by a cooling medium, in particular a gaseous cooling medium.

10. An apparatus for the connection of objects (16, 18) by means of at least one plasticizable hollow cylindrical rivet peg (20) having a process element (26) which is movable in the longitudinal direction (L) of the hollow cylindrical rivet peg (20) and pressable against it, by which the rivet peg (20) can be heated, the process element being provided at its process side which can be brought into engagement with said rivet peg with a spigot (32) which can be introduced into the hollow space (30) of the rivet peg (20) and with an annular cut-out (34) surrounding it for the formation of a rivet head (36) at the rivet peg (20),
characterized in that
the spigot (32) and the annular cut-out (34) of the process element (26) surrounding it are made such that a spreading effect directed from the inside to the outside is exerted onto the heated rivet peg (20) in a doughy state generally transversely to the longitudinal direction (L) of the rivet peg (20) during the follow-up movement of the process element (26) applied to the rivet peg (20) and in that the rivet peg (20) is beaded over in the doughy state for the shaping of the rivet head (36).

11. An apparatus in accordance with claim 10, characterized in that the process element (36) has at its process side (28) a support surface (38) which surrounds the cut-out (34) in annular form and with which it lies on one (18) of the objects (16, 18) to be connected to one another at the end of its follow-up movement.

12. An apparatus in accordance with claim 11, characterized in that the spigot (32) of the process element (26) projects beyond the plane (40) of the support surface (38).

13. An apparatus in accordance with claim 10, characterized in that the process element (26) is made rotationally symmetrical.

14. An apparatus in accordance with claim 10, characterized in that the spigot (32) has, starting from its outer end (42) projecting beyond the plane (40) of the support surface (38), an outer diameter which becomes increasingly larger inwardly.

15. An apparatus in accordance with claim 10, characterized in that the outer diameter of the spigot (32) is at least substantially the same as the inner diameter (d) of the hollow cylindrical rivet peg (20) in the plane (40).

16. An apparatus in accordance with claim 10, characterized in that the outer diameter of the spigot (32) is larger than the inner diameter of the hollow cylindrical rivet peg (20) at least in the region disposed in the longitudinal direction (L) of the rivet peg (20) considered within the plane (40) of the support surface (38).

17. An apparatus in accordance with claim 10, characterized in that the spigot (32) has a conical or truncated conical shape at least section-wise.

18. An apparatus in accordance with claim 10, characterized in that the peripheral surface of the conical or truncated conical section of the spigot (32) includes an angle (β) in the range of approximately 15° with the longitudinal direction (L) of the rivet peg (20).

19. An apparatus in accordance with claim 10, characterized in that the spigot (32) merges over a curved wall section (48) into the base (50) of the annular recess (34).

20. An apparatus in accordance with claim 10, characterized in that the base (50) of the annular recess (34) merges over a curved wall section (52) into the wall (54) outwardly bounding the recess (34) and adjoining the support surface (38).

21. An apparatus in accordance with claim 10, characterized in that the width (b) of the at least substantially planar base (50) of the cut-out (34) defining the maximum depth (t) of the annular cut-out (34) is larger than the outer diameter of the spigot (32) in the plane (40) of the support surface (38).

22. An apparatus in accordance with claim 10, characterized in that the wall (54) outwardly bounding the cut-out (34) is outwardly inclined by an angle (α) in the range from approximately 15° with respect to the longitudinal direction (L) of the rivet peg (20) in the region of the support surface (38).

23. An apparatus in accordance with claim 10, characterized in that the width of the annular cut-out (34) considered in the plane (40) of the support surface (38) is larger than the diameter of the spigot (32).

24. An apparatus in accordance with claim 23, characterized in that, considered in the plane (40) of the support surface (38), the width (x) of the annular cut-out (34) is at least twice as large, and preferably at least three times as large, as the diameter of the spigot (32).

25. An apparatus in accordance with claim 10, characterized in that the maximum depth (t) of the cut-out (34) measured starting from the plane (40) of the support surface (38) is larger than the height (h) of the part of the spigot (32) projecting beyond the plane (40) of the support surface (32).

26. An apparatus in accordance with claim 10, characterized in that the ratio between the maximum depth (t) of the cut-out (34) and the height (h) of the part of the spigot (32) projecting beyond the plane (40) of the support surface (38) is in a range between approximately 1.4 and approximately 1.7.

27. An apparatus in accordance with claim 10, characterized in that means are provided to control and/or regulate the heating of the rivet peg (20) such that it is only heated so much that it is transformed into the doughy state and a melting off is prevented.

28. An apparatus in accordance with claim 10, characterized in that means are provided to control and/or regulate the force with which the process element (26) is pressed toward the rivet peg (20) such that the process element (26) applied to the rivet peg (20) follows up the rivet peg (20) adopting its doughy state and the rivet peg (20) is beaded over in this doughy state.

29. An apparatus in accordance with claim 10, characterized in that the process element (26) is provided for the forming of the rivet head (36) at an at least substantially circular cylindrical rivet peg (20) with a rotationally symmetrical spigot (32) and with a rotationally symmetrical annular cut-out (34).

30. An apparatus in accordance with claim 10, characterized in that the process element (26) is formed by a heatable cap or the like.

31. An apparatus in accordance with claim 10, characterized in that the process element (26) is formed by a sonotrode.

32. An apparatus in accordance with claim 10s, characterized in that the process element (26) preferably formed by a heatable cap is associated with a riveting tool which can be moved backward and forward in the direction of the rivet peg (20) and which additionally includes a heating element which is designed to heat the process element (26) and which is movable relative to the process element (26).

33. An apparatus in accordance with claim 32, characterized in that the heating element is made as a heat accumulator.

34. An apparatus in accordance with claim 32, characterized in that it has means for the cooling of the process element (26).
